(19) United States
(12) Patent Application Publication
(10) Pub. No.: US 2015/0162800 A1
(43) Pub. Date: Jun. 11, 2015

(54) Actuator Compromising Two Magnetic Bearing Motors

(71) Applicant: WHYLOT SAS, Cambes (FR)

(72) Inventors: Romain Ravaud, Corn (FR); Jeremy Mech, Camburat (FR)

(21) Appl. No.: 14/413,924

(22) PCT Filed: Jul. 12, 2013
(86) PCT No.: PCT/FR2013/000190

§ 371 Date: Jan. 9, 2015

(30) Foreign Application Priority Data
Jul. 17, 2012 (FR) 1256906

(51) Int. Cl. H02K 7/09

(52) U.S. Cl. CPC H02K 7/09

(57) ABSTRACT

The invention relates to an actuator comprising two magnetic bearing motors. The actuator is characterized in that it comprises two magnetic bearing motors (I, Ibis), one extending from the other, said two bearing motors (I, Ibis) being offset angularly in relation to one another. The actuator is also characterized in that an active or passive stop (13) is disposed between the two bearing motors (I, Ibis), said stop (13) acting on the rotor (3, 3bis) and stator (4, 4bis) parts of each bearing motor (I, Ibis), a housing (10) being provided in the actuator between the first and second bearing motors (I, Ibis) for receiving the stop (13). The invention is suitable for use in the field of electric machines.

This application claims the benefit of U.S. 5 Non-Provisional Application of WHYLOT, International application number PCT/FR2013/000190, filed 12 Jul. 2013, having the title for ACTUATOR COMPRISING TWO MAGNETIC BEARING MOTORS, which is incorporated herein by reference in its entirety.

The present invention relates to an actuator comprising two magnetic bearing motors.

Traditional electric motors or generators require bearings in order to support and guide the rotation of a transmission shaft. The majority of the mechanical members used in current applications are ball bearings or sleeve bearings. Their operating limits are nevertheless very quickly reached in applications with very high speeds of rotation, with a specific atmosphere or in a vacuum, at very low or very high temperatures, or in fields where friction and wear must be minimized.

In that case, it is known to use magnetic bearings for electric motors or generators, those magnetic bearings not being subject to wear caused by friction. Such a magnetic bearing ensures that there is no contact between the stationary part of a motor, called the stator, and the moving part of said motor, called the rotor, the rotor and the stator being separated by an air gap of several tenths of millimeters.

Thus, it is known to use a motor with a magnetic bearing system in order to respond to the aforementioned operating constraints. To that end, a bearing motor has been developed forming a dual function actuator that incorporates the windings of radial bearing and the motor in a single actuator.

Such an actuator makes it possible to reduce the number of elements in the rotating system and to retain independent control of the torque and the radial forces. Configurations with shared windings of the bearing and the motor on a single device also exist.

Embodiments of bearing motors include certain defects, such as a magnetic circuit containing iron, which is responsible for an additional loss caused by Eddy currents at high frequencies. Bearing motors also require power electronics rich with communication cells as well as complex control methods, which slows their industrialization.

Two types of magnetic bearings may exist, called passive bearings and active bearings. A passive magnetic bearing uses permanent magnets, while an active magnetic bearing uses a coil traveled by a current around a magnetic circuit, said coil making it possible to create attractive forces in its environment. As previously mentioned, the active bearings are controlled to obtain effective support of the shaft, by control electronics that are often sophisticated and costly.

When the object rotates around its axis, which is most often central, five degrees of freedom must be controlled, which can be broken down into three degrees of translational freedom and two degrees of rotational freedom. This cannot be done using passive bearings; at least one active bearing is needed. Controlling an active magnetic suspension, however, introduces losses as well as safety and reliability problems.

Another loss source is due to the presence of iron in the component elements of the actuator or the part that it drives. The presence of iron in said elements is responsible for additional losses caused by Eddy currents, particularly at high frequencies. The actuator and the associated part also naturally lose their charge when they are not used.

Document EP-A-2 107 668 describes a rotating electric machine, in which a magnetic support force can be produced even when the rotor is quite long. The rotating electric machine comprises a rotor mounted on the main shaft and a stator surrounding the rotor.
The rotor has a first section producing a rotational torque in the circumferential direction of the shaft of the rotor or of the torque and the bearing force, and a second section creating an outward bearing force in the radial direction of the shaft of the rotor.
The two sections of the rotor are positioned in tandem along the main shaft. This document therefore relates to a single bearing motor having the same drawbacks as the aforementioned state of the art.

An illustration of the state of the art indicated in that document cites a bearing motor having two rotors spaced apart from each other and cooperating with a stator made in a single piece. This state of the art therefore has the same drawbacks as previously mentioned.

Document WO-A-02/40884 describes a rotating machine with a rotating shaft supported by first and second radial magnetic bearings, the current of which is steered by a control device. The rotating shaft is equipped with an axial bearing comprising a rotor formed by a rigidly fastened disc. This document does not describe any bearing motor, but only radial magnetic bearings, and has the same drawbacks as previously mentioned.

The aim of the present invention is to provide an actuator making it possible to decrease all of the friction that it undergoes during operation and to rotate its driveshaft while eliminating parasitic movements that may be caused during its rotation.

To that end, the present invention relates to an actuator with at least one magnetic bearing motor, said at least one motor comprising a rotor and a stator, the rotor being magnetically suspended relative to the stator, characterized in that it comprises two magnetic bearing motors positioned in the extension of one another, the two bearing motors being angularly offset relative to one another, and in that an active or passive bearing is inserted between the two bearing motors, said bearing acting on the rotor and stator parts of each bearing motor, a housing being provided on the actuator between the first and second bearing motors to receive the bearing.

Such an actuator with two bearing motors makes it possible to guarantee a constant torque for the rotational shaft, the torque of one of the bearing motors being able to be zero in certain annular positions and being offset by the torque of the other bearing motor.

According to preferred features of the present invention:

the two bearing motors are offset by a mechanical angle of 22.5°.

the rotor part of each bearing motor is formed by magnets symmetrically distributed around the stator part of said bearing motor.

the magnets are distributed so as to form a Halbach structure making it possible to create a magnetic flow with an asymmetrical profile, said flow being amplified on one side of the structure while being decreased or even canceled on the other side.

the magnets have a base of lanthanides, organometallic magnets or organic magnets.

the stator and rotor are made from a composite or ceramic material.

the stator part of each bearing motor is formed by a substantially cylindrical core having slots for the passage of at least one coil between two consecutive slots.

the three groups of coils are mounted in a star, the sum of the three currents for each bearing motor being zero.

the actuator comprises means for commanding and controlling positioning parameters by varying currents transmitted to said at least one coil, detecting means in the form of at least one inductive sensor being provided on said actuator, the control means being active on the intensity of the currents transmitted to the coils of each bearing motor.

The invention also relates to a method for controlling such an actuator, comprising a step for varying the currents transmitted to said at least one coil of the stator of the actuator, said step being carried out based on the position and torque of the actuator.

Advantageously, said at least one coil of each bearing motor is supplied with at least one current, and the intensity of the current of the second bearing motor may or may not be different from the intensity of the current of the first bearing motor.

Advantageously, each bearing motor is powered by at least three currents, each current powering a respective group of coils, the three currents of the first bearing motor being able to be different from or the same as the three currents of the second bearing motor.

The invention will now be described in more detail, but non-limitingly, in relation to the appended figures, in which:

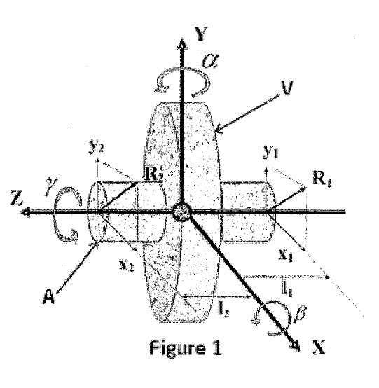

FIG. 1 shows a perspective view of an element driven around an axis, indicating the various degrees of freedom,

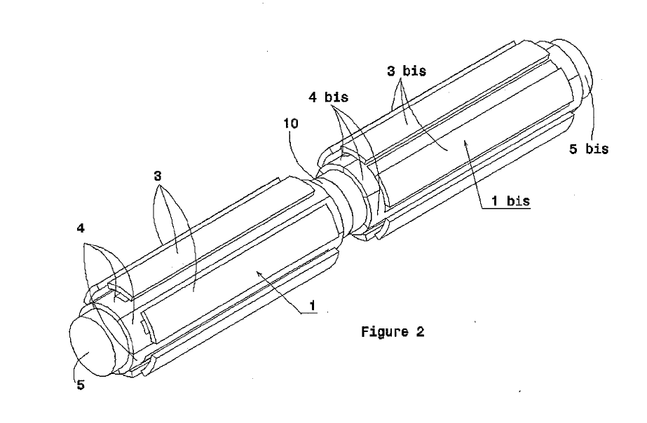

FIG. 2 shows a perspective view of an actuator made up of two bearing motors according to the present invention,

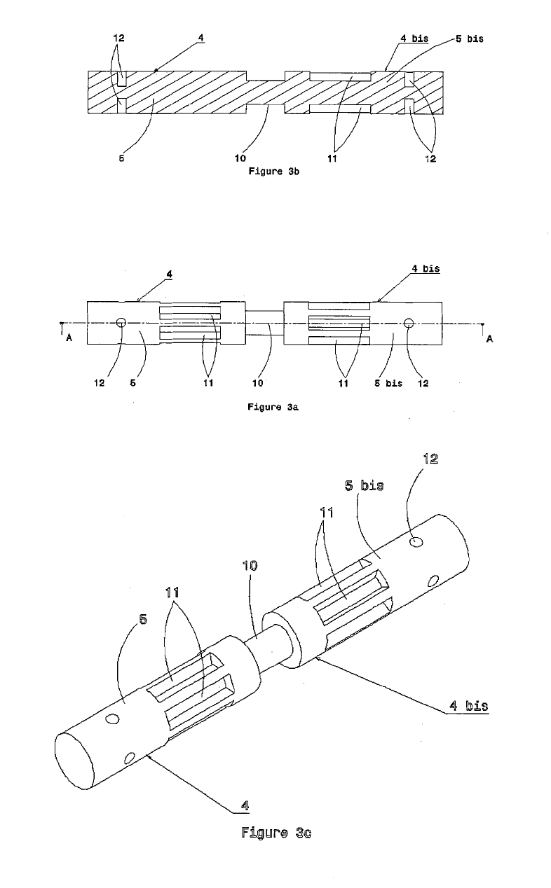

FIG. 3a shows a side view of the stator for an actuator according to the present invention, said stator being formed by two stator parts, each of which corresponds to a bearing motor,

FIG. 3b shows a longitudinal cross-sectional view of the stator of FIG. 3a,

FIG. 3c shows a perspective view of the stator of FIG. 3a,

FIG. 3d shows a developed view of a winding on the stator of FIG. 3a,

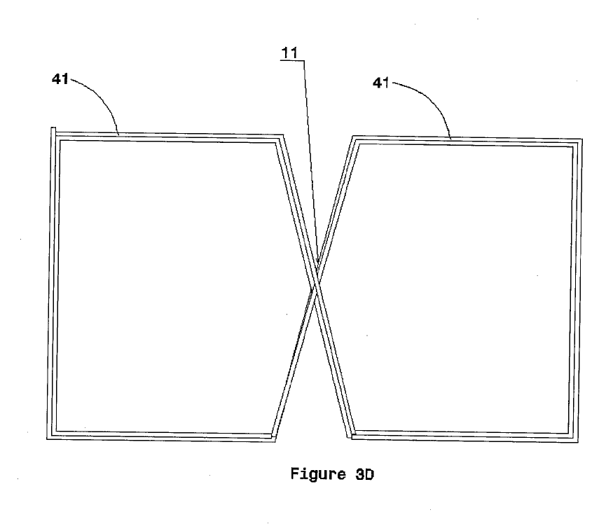

FIG. 4 shows a cross-sectional view along A-A of the first bearing motor of the actuator according to the present invention,

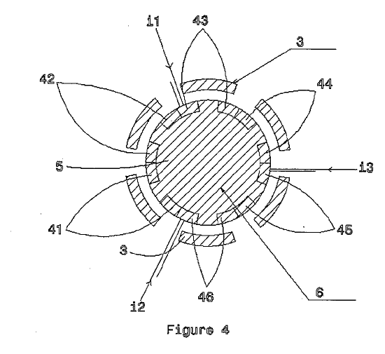

FIG. 5 shows a cross-sectional view along B-B of the second bearing motor of the actuator according to the present invention,

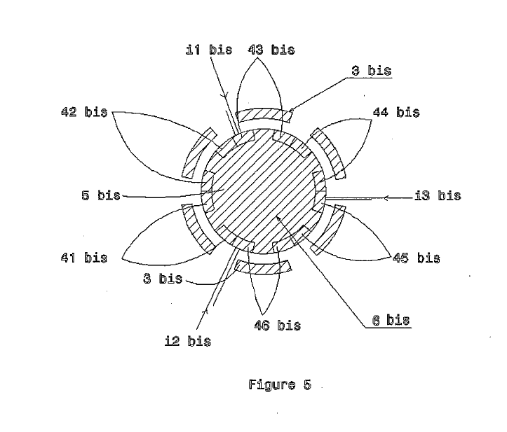

FIG. 6 shows a cross-sectional view along A-A or B-B of a bearing motor of the actuator according to another embodiment of the present invention, the magnets of the rotor in this figure being placed in a Halbach arrangement,

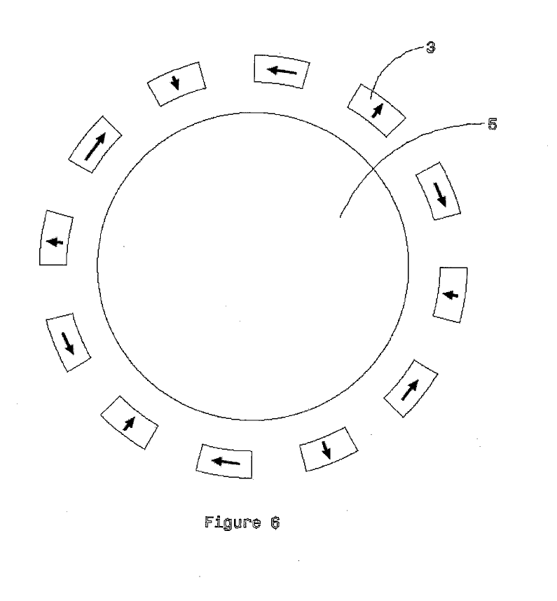

FIG. 7 shows a perspective view of a magnetic bearing that can be inserted between the two bearing motors of the actuator according to the invention,

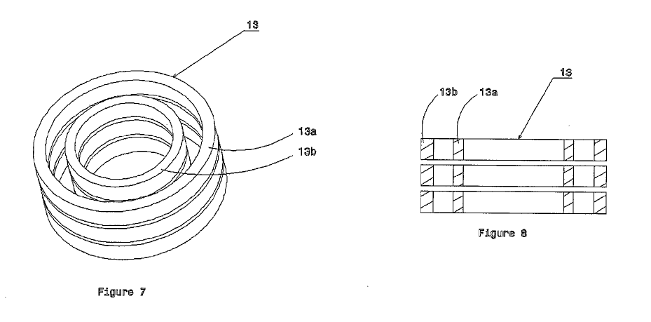

FIG. 8 shows an axial cross-sectional view of the bearing of FIG. 7, and

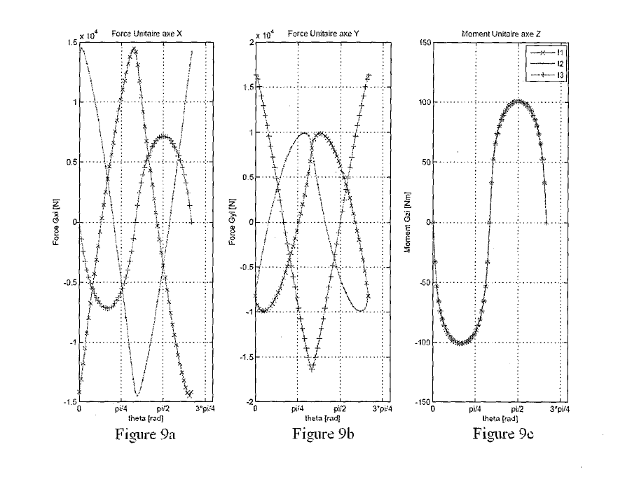

FIGS. 9a, 9b and 9c show the force curves along the axes X, Y and Z shown in FIG. 1, respectively.

FIG. 1 shows a rotating element V and its shaft A, the rotating element being able to be a flywheel. This figure indicates the possible degrees of freedom of the rotating element V.

Assuming that this rotating element V is completely free, its spatial movement can be described by the combination of three translations and three rotations relative to an orthonormal reference that is shown with an axis Z extending along the axis of the rotation shaft A of the element V, an axis Y contained in the plane of the element V, the axis X being perpendicular to the first two axes Z and Y.

The three degrees of rotational freedom are respectively the rotation α around the axis Y, the rotation β around the axis X and the rotation γ around the axis Z. In the case of a flywheel V intended to rotate around the axis Z, only the rotation γ must be free, the other rotations being considered parasitic rotations.

Still assuming that the element V is completely free, there are three degrees of translational freedom along the axes X, Y and Z. This can occur at both ends of the shaft A of the element V, and these degrees of translational freedom should be limited to obtain optimal operation of the rotating element V with its shaft A. Monitoring should be done to make sure that no offset is created at the two ends of the shaft A, that offset being able to be summarized as two respective components X1, Y1 and X2, Y2 yielding a respective resultant R1 and R2, relative to an orthonormal reference centered on each of the ends.

According to the present invention, an actuator is used having two bearing motors that are angularly offset relative to one another; said bearing motors will be described in more detail later. An angular offset of the two bearing motors relative to one another refers to an offset relative to the poles of the bearing motors relative to one another.

The two bearing motors can be similar or have different designs. Using two bearing motors that are angularly offset relative to one another makes it possible to transmit a motor torque by rotational action γ around the axis Z, but also to exert radial forces to control the forces R1 and R2 as well as the rotations α and β. The degree of translational freedom along the axis Z is maintained by a magnetic bearing, which is advantageously passive. This pertains to the friction losses that the present invention wishes to reduce.

For losses caused by Eddy currents, the present invention provides for making the actuator and the associated element from nonferrous materials. This is for example particularly valid for the magnets of the rotor parts and stator parts of the actuator with two bearing motors.

The actuator according to the present invention will be described in reference to FIGS. 2 to 5. The actuator according to the invention combines the characteristics of a synchronous electric machine with permanent magnets with the magnetic bearing functions.

The actuator is made up of two angularly offset bearing motors 1 and ibis. This makes it possible to guarantee a constant torque for the rotation shaft, the torque of one of the bearing motors 1 or ibis being able to be zero in certain angular positions and being offset by the torque of the other bearing motor ibis or 1. The two bearing motors 1 and ibis that are part of the actuator can be synchronous machines with permanent magnets in the rotor part.

In FIGS. 2 to 5, the bearing motors 1 and 1bis are made up of six poles and three coils in the example below, but other structures are possible in order to control several axes, such as the bearing motor with four poles and coils.

Each bearing motor 1 and 1bis first has an outer rotor with polarized and alternating permanent magnets 3 and 3bis. The polarized and alternating permanent magnets 3 and 3bis can be arranged either traditionally or using a Halbach structure. It is also possible to have an inner rotor surrounded by a stator.

As shown by FIG. 6 illustrating a Halbach structure, the arrangement of the magnets 3 and 3bis in such a structure makes it possible to amplify the magnetic field on one side of the magnets 3 and 3bis while the magnetic field is canceled out on the other side of the magnets 3 and 3bis. In this figure, the arrows in the magnets 3, 3bis indicate the direction of the magnetic field.

The permanent magnets 3 and 3bis are advantageously fastened directly on the rotating portion, which makes it possible to eliminate the coupling of the rotor and the magnets 3 and 3bis. The inner stator carries coils 4. The coils 4 can advantageously be made from copper or aluminum.

As shown particularly well in FIGS. 3a, 3b, 3c and 3d, the stator is formed by a core 5 corresponding to the stator part 4 of the first bearing motor 1 and a core 5bis corresponding to the stator part 4bis of the second bearing motor. The cores 5, 5bis have a substantially cylindrical shape, and a housing 10 is provided between the cores 5 and 5bis for a magnetic bearing that will be described later. The stator shown in FIGS. 3a to 3c also comprises a cavity 12 for receiving an inductive sensor, said inductive sensor delivering a signal making it possible to control the position of the shaft supporting the actuator.

Each core 5, 5bis has slots 11, which are preferably longitudinal, advantageously six slots 11 for winding coils on the peripheral portion of the core 5, 5bis delimited by two adjacent slots 11.

FIG. 3c shows that the stator part of the first bearing motor 1 and the stator part of the second bearing motor ibis are angularly offset relative to one another, the slots 11 of the first stator being angularly offset relative to the slots 11 of the second stator.

FIG. 3d shows a developed view of a winding connecting two coils 41 between a slot 11. This winding may advantageously form an X between the two adjacent coils 41 of a stator. This is also valid for the coils 41 to 46 as well as 41bis to 46bis, which will be shown in FIGS. 4 and 5.

As shown particularly well in FIGS. 4 and 5, the stator part that is inside each bearing motor 1, 1bis is made up of six coils 41 to 46, 41bis to 46bis on the core 5, 5bis with low permeability, advantageously around peripheral portions of the core 5, 5bis that are delimited by two adjacent slots 11, as shown in FIG. 3d.

In light of FIGS. 4 and 5, in order to decrease losses due to the presence of iron, the core 5, 5bis advantageously does not contain iron. The winding of a phase is made up of two adjacent coils, connected by a circuit 6 or 6bis, only one of which is referenced in FIG. 4 or 5. Such an assembly contributes to generating a motor torque and a radial force on the rotor. The three coils 41 to 46, 41bis to 46bis are coupled in a star and powered by three currents i1, i2, i3 or i1bis, i2bis, i3bis, the sum of which is zero for each of the bearing motors 1 or 1bis.

FIG. 6 illustrates an embodiment of the bearing motor different from that shown in FIGS. 4 and 5. In FIG. 6, the magnets 3 are positioned using a Halbach structure. Such a structure increases the magnetic field on one side of the bearing motor while it decreases it or cancels it out on the other side.

The Halbach structure comprises twelve magnets 3 forming the rotor part of a bearing motor with arrows symbolizing the direction of the magnetic field. The stator part of the bearing motor remains substantially unchanged relative to FIGS. 4 and 5. For an actuator, it is possible to use a Halbach structure for each bearing motor provided on the actuator, which has the advantage of allowing better flow concentration and directly increases the performance of the actuator, the two bearing motors having an angular offset between them.

In reference to all of the figures, the bearing motor structure 1 or 1bis allows independent and uncoupled control of the three degrees of freedom X, Y and Z using digital control of the three currents i1, i2, i3 or i1bis, i2bis, i3bis based on the position and the torque.

The electronic control of the actuator according to the present invention comprises means for commanding and controlling positioning parameters of its shaft by varying the currents transmitted to said at least one coil, i.e., in the figures, three groups of coils per bearing motor. This electronic control also comprises detection means, for example in the form of at least one inductive sensor, provided on the actuator previously described.

Thus, the detection means monitor the position of the rotor of the actuator relative to its stator and the control means are active on the intensity of the currents transmitted to the coils of each bearing motor in order to return the rotor to its predetermined work position. The rotor thus remains levitated with respect to the stator while being kept at a very small distance from the stator, in a safe manner.

The actuator only requires three inverter arms to power the coils 41 to 46, 41bis to 46bis using non-sinusoidal currents. The digital control of the three switching cells of the inverter makes it possible to generate constant forces independent of the angle of rotation, while the torque is zero in certain angular positions. It is therefore only possible to guarantee a constant torque by associating two angularly offset bearing motors 1 or 1bis, as proposed by the present invention.

In one preferred embodiment of the invention, the actuator is made up of two bearing motors 1, ibis that are angularly offset by 90 electrical degrees or an angle of 22.5 mechanical degrees for a motor with six poles. Aside from the advantage of obtaining a constant torque independently of the angle of rotation, the two associated bearing motors 1, 1bis make it possible to control the two additional degrees of rotational freedom, called rotation α around the axis Y and rotation β around the axis X in light of FIG. 1.

By controlling six non-sinusoidal currents, the actuator according to the present invention makes it possible to create completely uncoupled forces and moments based on the position and torque of the motor.

The magnets used in the bearing motors 1, 1bis of the present invention do not contain iron. They advantageously have a base of lanthanides, also called rare earths, for example samarium cobalt. Alternatively, the magnets can be coordination chemistry magnets, organometallic magnets, for example vanadium di-tetracyanoethylene or neodymium iron boron with a very low iron content and/or purely organic magnets, for example CHNO.

Elements other than iron are preferred to produce the actuator. These elements may have a composite or ceramic base.

FIGS. 7 and 8 show a magnetic bearing 13. The bearing between the first and second bearing motors 1, 1bis may be positioned in a housing 10, as in particular shown in FIGS. 2, 3a to 3c. It should be noted that this magnetic bearing can be passive or active.

As non-limitingly illustrated in these two figures, the magnetic bearing 13 can comprise a series of three concentric rings 13a serving as a bearing for the rotor of the two bearing motors and a series of three concentric rings 13b serving as a bearing for the stator of the two bearing motors.

FIGS. 9a, 9b and 9c respectively show the unitary force curves along the axis X, the unitary force along the axis Y and the unitary stress along the axis Z based on the angle of rotation of the actuator, for each of the two bearing motors, the curve in dotted lines designating that of one of the bearing motors and the curve with circles designating the other bearing motor.

FIG. 9c shows that the unitary stress curves of axis Z are reversed. The stress curve of a bearing motor may have a zero value for certain angular positions; it is therefore then only possible to obtain a constant stress by associating two angularly offset bearing motors.

Due to the control of six non-sinusoidal currents, the actuator according the present invention makes it possible to create forces and stresses that are completely uncoupled based on the motor position and torque.

The actuator with two bearing motors according to the present invention has a robust and cost-effective design. Due to the presence of at least one inductive sensor, better monitoring and better control of the movement of the actuator are possible, resulting in performance and reliability gains for the actuator.

Such an actuator with two bearing motors is not subject to friction, the magnetic bearings operating without contact, which decreases the energy consumption and increases the lifetime of the actuator. The lack of contact also makes it possible to reduce the noise emitted by the actuator during its movement. This makes it possible to increase the speed with a possible reduction in the size of the actuator with bearing motors relative to an actuator of the state of the art.

With such an actuator with two magnetic bearing motors, due to the
constant control of the coils, the control being steered by at least one inductive sensor, the actuator can be controlled very safely.

An actuator has been shown with bearing motors having an inner stator and an inner rotor, but this may be reversed.

The invention is in no way limited to the described and illustrated embodiment, which is provided solely as an example.

What I claim is:

1. An actuator with at least one magnetic bearing motor, said at least one motor comprising a rotor (3, 3bis) and a stator (4, 4bis), the rotor (3, 3bis) being magnetically suspended relative to the stator (4, 4bis), characterized in that it comprises two magnetic bearing motors (1, 1bis) positioned in the extension of one another, the two bearing motors (1, 1bis) being angularly offset relative to one another, and in that an active or passive stop (13) is inserted between the two bearing motors (1, 1bis), said stop (13) acting on the rotor (3, 3bis) and stator (4, 4bis) parts of each bearing motor (1, 1bis), a housing (10) being provided on the actuator between the first and second bearing motors (1, 1bis) to receive the stop (13).

2. The actuator according to claim 1, characterized in that the two bearing motors (1, 1bis) are offset by a mechanical angle of 22.5°.

3. The actuator according to any one of the preceding claims, characterized in that the rotor part (3, 3bis) of each bearing motor (1, 1bis) is formed by magnets (3, 3bis) symmetrically distributed around the stator part (4, 4bis) of said bearing motor (1, 1bis).

4. The actuator according to the preceding claim, characterized in that the magnets (3, 3bis) are distributed so as to form a Halbach structure making it possible to create a magnetic flow with an asymmetrical profile, said flow being amplified on one side of the structure while being decreased or even canceled on the other side.

5. The actuator according to any one of the two preceding claims, characterized in that the magnets (3, 3bis) have a base of lanthanides, organometallic magnets or organic magnets.

6. The actuator according to any one of the preceding claims, characterized in that the stator (4, 4bis) and rotor (3, 3bis) are made from a composite or ceramic material.

7. The actuator according to any one of the preceding claims, characterized in that the stator part (4, 4bis) of each bearing motor (1, 1bis) is formed by a substantially cylindrical core (5) having slots (11) for the passage of at least one coil (41 to 46, 4 ibis to 46bis) between two consecutive slots.

8. The actuator according to the preceding claim, characterized in that each bearing motor (1, 1bis) comprises three groups of coils (41 to 46, 41bis to 46bis) mounted in a star, the sum of the three currents (i1 to i3, i1bis to i3bis) for each bearing motor (1, 1bis) being zero.

9. The actuator according to any one of the two preceding claims, characterized in that it comprises means for commanding and controlling positioning parameters by varying currents (i1 to i3, i1bis to i3bis) transmitted to said at least one coil (41 to 46, 41bis to 46bis) of each motor (1, 1bis), detecting means in the form of at least one inductive sensor (12) being provided on said actuator, the control means being active on the intensity of the currents (i1 to i3, i1bis to i3bis) transmitted to the coils (41 to 46, 41bis to 46bis) of each bearing motor (1, 1bis).

10. A method for controlling an actuator according to the preceding claim, comprising a step for varying the currents (i1 to i3, i1bis to i3bis) transmitted to said at least one coil (41 to 46, 41bis to 46bis) of the stator of each bearing motor (1, 1bis) of the actuator, said step being carried out based on the position and torque of the actuator.

11. The method according to the preceding claim, characterized in that said at least one coil (41 to 46, 41bis to 46bis) of each bearing motor (1, 1bis) is supplied with at least one current, the intensity (i1bis to i3bis) of the current of the second bearing motor (1bis) being able to be different from or the same as the intensity of the current (i1 to i3) of the first bearing motor (1).

12. The method according to the preceding claim, characterized in that each bearing motor (1, 1bis) is powered by at least three currents (i1 to i3, i1bis to i3bis), each current (i1 to i3, i1bis to i3bis) powering a respective group of coils (41 to 46, 4 ibis to 46bis), the three currents (i1 to i3) of the first bearing motor (1) being able to be different from or the same as the three currents (i1bis to i3bis) of the second bearing motor (ibis).
